(19) United States
(12) Patent Application Publication
(10) Pub. No.: US 2025/0115001 A1
(43) Pub. Date: Apr. 10, 2025

(54) METHOD FOR MAKING AN INTERNALLY ILLUMINABLE 3D PRINTED MODEL OF A BUILDING BASED ON A MULTI-MATERIAL 3D DIGITAL MODEL OF THE BUILDING AND AN INTERNALLY ILLUMINABLE 3D PRINTED MODEL OF A BUILDING SO MADE

(71) Applicant: Andrew C. Rieder, Newtown, PA (US)

(72) Inventor: Andrew C. Rieder, Newtown, PA (US)

(21) Appl. No.: 18/484,406

(22) Filed: Oct. 10, 2023

(51) Int. Cl. B29C 64/386; B29C 64/336; B29L 31/40; B33Y 10/00; B33Y 50/00; B33Y 80/00; G09B 25/04

(52) U.S. Cl. CPC B29C 64/386; B29C 64/336; G09B 25/04; B29L 2031/40; B33Y 10/00; B33Y 50/00; B33Y 80/00

(57) ABSTRACT

A building model having lit windows that looks more realistic and visually pleasing than known building models. The building model includes a central lighting source that provides light substantially evenly along the entire height of the building model. For example, an LED strip is wrapped around a support structure that extends centrally upward within the building. The building model can include a translucent diffuser placed up against or close to the window holes of the building model that diffuses the light, preventing the problems when one can see the inside the model though the window holes. The diffuser prevents shimmering and blinking effects, and keeps the light level substantially even over the entire outer surface of the building model, which is more pleasing to the eye, and more closely resembles buildings in the real world. The building and the diffuser can be printed sequentially, or can be printed simultaneously.

### CROSS-REFERENCES TO RELATED APPLICATIONS

This application gets priority from Provisional Patent Application 63/414,734 entitled METHOD FOR MAKING AN INTERNALLY ILLUMINABLE 3D PRINTED MODEL OF A BUILDING BASED ON A 3D MODEL OF THE BUILDING, filed Oct. 10, 2022, herein incorporated by reference in its entirety.

### FIELD OF THE INVENTION

This invention relates generally to 3D printed models of buildings, and more particularly to 3D printed models of buildings with lit windows.

### BACKGROUND OF THE INVENTION

3D printed models of buildings with windows that light up in a scattered assortment, as is typical in cities at night, are known. These models are hollow on the inside, and have holes cut through the walls that enable light to shine through to create the appearance of illuminated windows. An internal lighting source shines through the holes which creates an illumination effect. These models are lit using a light source that shines upward and outward from a bottom inside surface. The building model is 3D printed as a single piece, which is then attached to a bottom plate that closes the bottom, the bottom plate also supporting the light source.

These building models can provide a source of value for hobbyists who want to incorporate lit buildings into their displays, for collectors of souvenir buildings (or various souvenirs of specific buildings), and for people who want to decorate their place of residence, for example.

One problem with these building models is the light source placed on the bottom plate that shines upwards and outwards. In general, a single light source placed off to one side of a volume (not in the center) will produce an unequal distribution of light on the inner surfaces of the volume. Further, a non-spherical volume will experience unequal light distribution on the inner surfaces, regardless of where the light source is placed. In the case of the known models discussed above, the light source cast light from the bottom of the model which causes windows in the bottom half of the building model to appear much brighter than windows in the top half of the building model. The difference in brightness of the light shining through the windows as a function of the elevation of the windows is less in short buildings than the difference that is observable in taller building models. Such a difference in brightness that depends on the elevation of the window is not found in real life-sized buildings. For example, a room on the 100^{th} floor of a real building is typically illuminated by the same lights as a room on the 10^{th} floor of the building, and is therefore just as bright.

Another problem with known building models is that the window holes are open to the inside of the model. When there is nothing in between the light source and the window holes, light rays coming through the window holes are either coming directly from the light source itself, or are due to reflections of the light source off the inner walls. This creates unrealistic lighting effects when viewing the building model.

For example, when looking at the building model at eye level, the light coming through the windows will appear brighter than when looking at the building model from below eye level, and will appear less bright than when looking at the building model from above eye level.

Another example of an unrealistic lighting effect occurs when observing the building model while moving relative to the building model. A shimmering and blinking effect occurs in the windows that is caused by uneven inner surfaces and window holes on the opposite side of the model.

### SUMMARY OF THE INVENTION

The building model of the invention looks more realistic and is more visually pleasing than known building models. To accomplish this, embodiments of the invention include a lighting source that provides light substantially evenly along the entire height of the building model, thereby preventing the bottom half of a building model from appearing much brighter than the top half.

In some embodiments, an LED strip is wrapped around a support structure that extends upward within the building. The strip is wound around the support structure in a spiral fashion. This light source is disposed within the building such that the LED strip faces the windows directly. The less the pitch at which the LED strip is spiraled around the support structure, the less dark regions will exist between each turn of the strip, which smooths out light distribution, but uses more LEDs.

Also, providing more separation between the light source and the internal surface of the model also results in better light distribution, but this can be more difficult to achieve in smaller-sized models where space is limited. Creating more distance, while improving light distribution, also requires that the lights be brighter to achieve a sufficient brightness level as seen from the outside of the building.

Both the pitch of the LED strip spiral, and the distance between the LEDs and the walls are adjustable, thereby providing freedom to customize the lighting in each building model so as to be as realistic as possible.

To further improve the realistic appearance of the lit windows, the building model of the invention includes translucent diffusers placed up against the window holes that diffuse the light, preventing the problems that occur when one can see the inside of the model though the window holes. When there is a diffuser between the light source and the window holes, the origin of the light rays coming through the window holes is not apparent.

The translucent diffusers placed up against the window holes eliminate the unrealistic shimmering and blinking effect that occurs when looking at the windows of the building model while moving. In the building model of the invention, all light shines through the diffusers before reaching the observer's eyes. Because all the light rays travel through the diffuser, reflections of light from the inner surfaces are of no consequence, and the window holes on the other side become irrelevant. Thus, the diffusers prevent any shimmering or blinking effects, and keep the light level substantially even over the entire outer surface of the building model, which is more pleasing to the eye, and results in an appearance that more closely resembles the appearance of buildings in the real world.

A general aspect of the invention is a method for making an internally illuminable 3D printed model of a building based on a 3D model of the building. The method includes: acquiring a 3D model of a building; using 3D software, hollowing out the 3D model of the building, so as to provide a 3D model of the building having a cavity with a downward opening; using 3D software, cutting a plurality of window holes through at least one side of the 3D model of the building having a cavity so as to provide a 3D model of the building having a cavity and a plurality of window holes; using 3D software, creating a diffuser insert array 3D model by including a diffuser insert for each location of a window hole so as to provide an array of diffuser inserts, each diffuser insert being located so as to reside within each window hole of the plurality of window holes; using 3D software, combining the building 3D model with the diffuser insert array 3D model by registering the building 3D model with respect to the diffuser insert array 3D model so as to produce a multi-material 3D model of the building, the building 3D model to be printed with at least one building material, and the diffuser insert array 3D model to be printed with at least one diffuser material; using a 3D printer, 3D printing the multi-material 3D model of the building using the at least one building material, and the at least one diffuser material; providing an inner support structure for supporting a vertically distributed lighting arrangement; applying the vertically distributed lighting arrangement to the inner support structure; and inserting the inner support structure with the vertically distributed lighting arrangement applied thereto into the 3D printed multi-material 3D model of the building to provide the internally illuminable 3D printed model of the building.

In some embodiments, the inner support structure is a rod.

In some embodiments, applying the vertically distributed lighting arrangement to the inner support structure includes wrapping an LED strip around the inner support structure.

In some embodiments, the inner support structure extends centrally through the 3D model of the building.

In some embodiments, providing the inner support structure for supporting the vertically distributed lighting arrangement includes: using 3D software, creating an inner support structure for supporting a vertically distributed lighting arrangement, the inner support structure attached to a bottom plate, the bottom plate configured to be attached to the multi-material 3D model of the building so as to cover the downward opening of the multi-material 3D model of the building; and using a 3D printer, 3D printing the inner support structure for supporting the vertically distributed lighting arrangement.

In some embodiments, the steps of: using 3D software, hollowing out the 3D model of the building, so as to provide a 3D model of the building having a cavity with a downward opening, and using 3D software, cutting a plurality of window holes through at least one side of the 3D model of the building having a cavity so as to provide a 3D model of the building having a cavity and a plurality of window holes, are performed simultaneously by: providing a negative 3D model representing the cavity with a downward opening and a plurality of window holes; adding the negative 3D model to the 3D model of the building so as to provide a 3D model of the building having a cavity and a plurality of window holes; and deselecting “Union Overlapping Volumes” feature so that the mesh can act as a negative.

In some embodiments, the 3D model of the building is a 3D model mesh, and the steps of: using 3D software, hollowing out the 3D model of the building, so as to provide a 3D model of the building having a cavity with a downward opening, and using 3D software, cutting a plurality of window holes through at least one side of the 3D model of the building having a cavity so as to provide a 3D model of the building having a cavity and a plurality of window holes, include the steps of: using 3D software, converting the 3D model mesh into a solid model of the building; using cut features in the 3D modeling software to make the inside of the 3D model hollow; and using cut features in the 3D modeling software to cut a plurality of window holes through at least one side of the solid model of the building so as to provide a solid model of the building having a plurality of window holes.

In some embodiments, cutting a plurality of window holes through at least one side of the solid model of the building so as to provide a solid model of the building having a plurality of window holes includes: before each hole of the plurality of window holes is cut, determining where each window hole of the plurality of window holes is to be cut, thereby determining locations of lit windows in the centrally illuminable 3D printed model of the building.

In some embodiments, determining where each window hole of the plurality of window holes is to be cut includes: determining locations of lit windows according to personal preference.

In some embodiments, determining where each window hole of the plurality of window holes is to be cut includes: determining locations of lit windows according to an automated process.

In some embodiments, the automated process includes: setting parameters for each floor of the building so as to obtain a desired lit window location pattern for each floor of the building; and determining the desired lit window location pattern for each floor of the building using the parameters.

In some embodiments, setting parameters includes: setting a density coefficient that determines a density of lit windows on each floor of the building, the density coefficient for each floor ranging from no lit windows on a floor to all lit windows on a floor; setting a maximum unlit horizontal window span, such that for each span of unlit windows greater than the maximum unlit horizontal window span, a lit window is inserted somewhere within the span; setting a lit window cluster probability that determines the likelihood that a previously placed lit window will have a cluster of lit windows placed next to the previously placed lit window; and setting a maximum lit window cluster length that determines a maximum number of lit windows that can be in a cluster of lit windows.

Another general aspect of the invention is an internally illuminable 3D printed model of a building based on a 3D model of the building, where the internally illuminable 3D printed model made according to a method including: acquiring a 3D model of a building; using 3D software, hollowing out the 3D model of the building, so as to provide a 3D model of the building having a cavity with a downward opening; using 3D software, cutting a plurality of window holes through at least one side of the 3D model of the building having a cavity so as to provide a 3D model of the building having a cavity and a plurality of window holes; using 3D software, creating a diffuser insert array 3D model by including a diffuser insert for each location of a window hole so as to provide an array of diffuser inserts, each diffuser insert being located so as to reside within each window hole of the plurality of window holes; using 3D software, combining the building 3D model with the diffuser insert array 3D model by registering the building 3D model with respect to the diffuser insert array 3D model so as to produce a multi-material 3D model of the building, the building 3D model to be printed with at least one building material, and the diffuser insert array 3D model to be printed with at least one diffuser material; using a 3D printer, 3D printing the multi-material 3D model of the building using the at least one building material, and the at least one diffuser material; providing an inner support structure for supporting a vertically distributed lighting arrangement; applying the vertically distributed lighting arrangement to the inner support structure; and inserting the inner support structure with the vertically distributed lighting arrangement applied thereto into the 3D printed multi-material 3D model of the building to provide the internally illuminable 3D printed model of the building.

### BRIEF DESCRIPTION OF THE DRAWINGS

Many additional features and advantages will become apparent to those skilled in the art upon reading the following description, when considered in conjunction with the accompanying drawings, wherein:

FIG. 1 is an isometric view of an embodiment of a solid model of a building having a plurality of window holes, the solid model of the building having a diffuser inside that is visible through each of the window holes, the solid model also having an inner support structure with a vertically distributed lighting arrangement applied thereto for internally illuminating the diffuser, which is visible through the window holes.

FIG. 2 is an isometric view of an embodiment of the diffuser of FIG. 1, showing descending tabs for attaching the diffuser to a bottom plate configured to support the solid model of the building.

FIG. 3 is an isometric view of an embodiment of the inner support structure without any lighting arrangement applied thereto.

FIG. 4 is an isometric view of the inner support structure of FIG. 3, showing the vertically distributed lighting arrangement of FIG. 1, particularly showing a helical distribution along the inner support structure.

FIG. 5 is a top-level flow chart of the process for making an internally illuminable 3D model of a building based on a 3D model of the building, by 3D printing the building and the diffuser sequentially.

FIG. 6 is a top-level flow chart of the process for making an internally illuminable 3D model of a building based on a 3D model of the building, by 3D printing the building and the diffuser simultaneously.

FIG. 7 is an isometric view of an embodiment of a solid model of a building having a plurality of window holes, the solid model of the building having a diffuser insert located within each window hole, each diffuser insert being 3D printed simultaneously with the 3D printing of the solid model, each diffuser insert being internally illuminable by a vertically distributed lighting arrangement applied to an inner support structure located inside the solid model of the building.

FIG. 8 is an isometric view of an embodiment of the diffusers of FIG. 7, showing each diffuser insert at a location within a window hole, without showing the solid model of the building having the window holes.

FIGS. 9A-9E are detailed flow charts of the process for making an internally illuminable 3D printed solid model of a building based on a 3D model of the building.

FIG. 10A-10B are detailed flow charts of the step of FIG. 9C for determining which windows of the solid model of the building will be lit.

### DETAILED DESCRIPTION

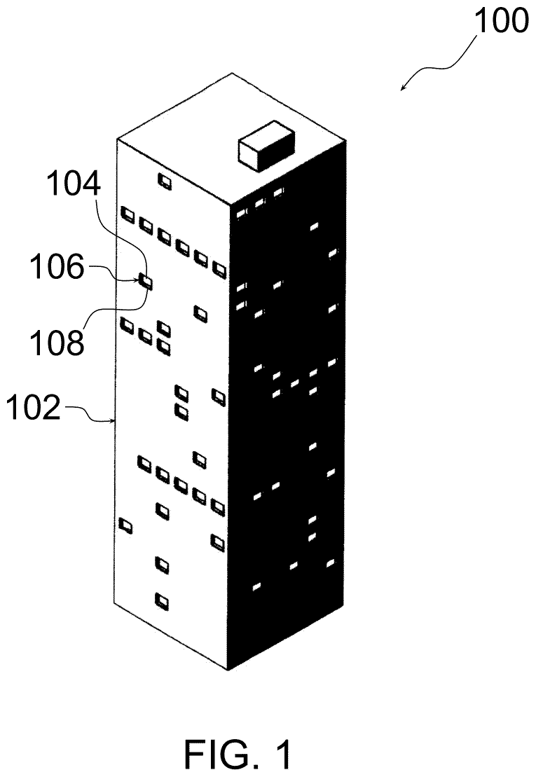

Referring to FIG. 1, an embodiment 100 of a solid model of a building having a plurality of window holes is shown as an example of a product made according to the method of the invention. The embodiment 100 is shown to have a building exterior 102 with window holes 104. An inner diffuser 106 is visible through all of the window holes 104. In this embodiment 100 each window hole 104 has a window hole recess 108, which is just an empty space in the building exterior 102, which encloses the inner diffuser 106.

The inner diffuser 106 is a structure made from a translucent material which diffuses light emitted from a distributed lighting arrangement (not shown) located inside the inner diffuser 106. One can 3D print the inner diffuser 106, or shape the inner diffuser 106 from a sheet of material by various means such as heat warping or injection molding, for example.

As the invention relates to 3D printing, common 3D printing materials one can use to make the building exterior 102 include: polylactic acid (PLA; biodegradable), Acrylonitrile Butadiene Styrene (ABS; heat resistant), Polyethylene Terephthalate (PET; recyclable), Nylon, High Impact Polystyrene (HIPS; durable), for example.

Common 3D printing materials one can use for the inner diffuser 106 include: Polyethylene Terephthalate Glycol (PETG), Polymethyl Methacrylate (PMMA), and some types of Nylon and PLA, for example.

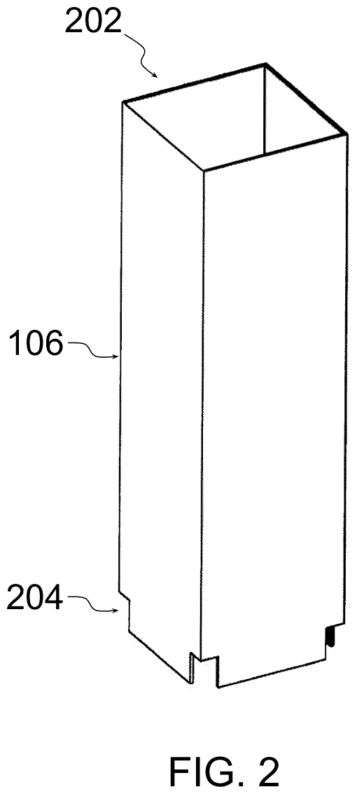

With reference to FIG. 2, the inner diffuser 106 of the embodiment 100 of FIG. 1 is shown. The main purpose of the inner diffuser 106 is to diffuse light emitted from a distributed lighting arrangement (not shown) located inside the inner diffuser 106 so that the light can be transmitted evenly through each window hole 104 of FIG. 1. Thus, any one of a variety of structures can be used as the inner diffuser 106, such as a cylinder, a rectangular tube, a square tube, or a shell of similar shape with smaller width/diameter relative to the building exterior 102.

It is recommended that the inner diffuser 106 be of a thickness and diffusiveness such that the effect created is that of an illuminated inner wall, without allowing a view of any inner surface of the building exterior 102. For example, a slight gap between the inner diffuser 106 and the inner surface of the building exterior 102 of FIG. 1 can produce a desirable effect.

Additionally, since the inner diffuser 106 encloses a light source which will generate heat and has electrical components, ventilation features can be incorporated, and non-flammable materials are preferred. The inner light diffuser 106 does allow for ventilation by way of top opening 202 and corner notches 204. The corner notches 204 also provide a passageway for electrical wires, and provide space for screws for attaching the inner light diffuser 106 to the inner support structure 300.

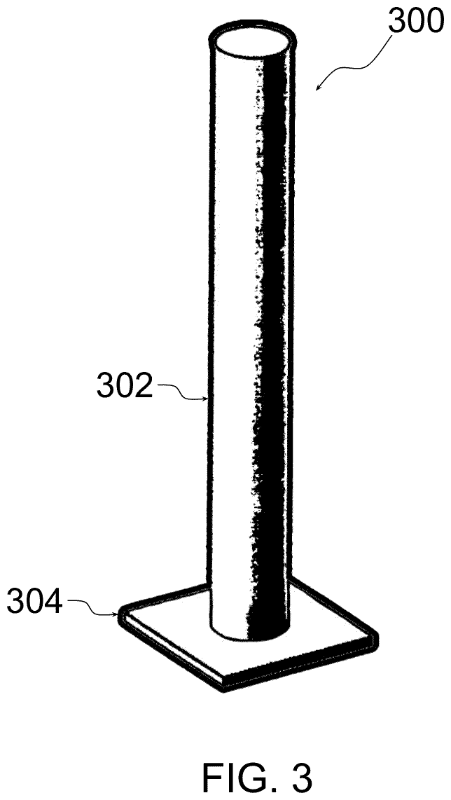

Referring to FIG. 3, an optional inner support structure 300 with a height commensurate with the height of the building exterior 102 of FIG. 1 is shown. This embodiment of the inner support structure 300 is made using a tube 302 that is 3D printed with PLA, ABS, for example, or it can be made from material such as cardboard or PVC. The tube 302 is attached to a base 304 made of a similar material.

In this embodiment, the inner support structure 300 is included so lights (e.g., LEDs) can be mounted helically to the structure 300 so as to produce a substantially even distribution of light emitting diodes (LEDs) over the surface of the structure 300, emitting light radially over the entire length of the support structure 300. By contrast, a point light source (e.g., a single light mounted at the base of the building exterior 102) will result in upper windows of the building exterior looking darker than lower windows.

Other embodiments of inner support structures can have various shapes, and materials, as long as the inner support structure can support a plurality of lights so as to create lighting that is of substantially similar intensity from the bottom of the building exterior 102 to the top of the building exterior 102.

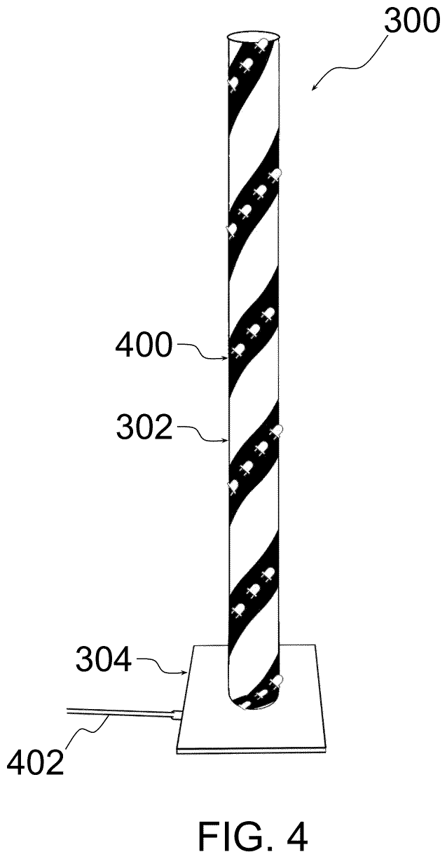

With reference to FIG. 4, the inner support structure 300 of FIG. 3 is shown, now wrapped helically with an LED strip 400, leaving a helical region 302 without lights. The helical region 302 without lights can be wide or narrow, the more narrow the helical region 302, the more LEDs per area of the surface of the inner support structure 200.

The wiring 402 of the LED strip 400 is shown emerging at the base 304 of the inner support structure 300. LED lights are only one of many light sources available, with possible alternatives including small incandescent bulbs, small halogen bulbs, or even the ends of fiber optic waveguides or thin fiber optic cables carrying light from a central source in the base 304, the ends of the fiber optic waveguides being directed radially outward and distributed along the inner support structure in a manner similar to the distribution of the LEDs shown in FIG. 4, for example. Alternatively, rather than extending through or under the base 304, the wiring 402 of the LED strip 400 can rest on top of the base 304 of the inner support structure 300.

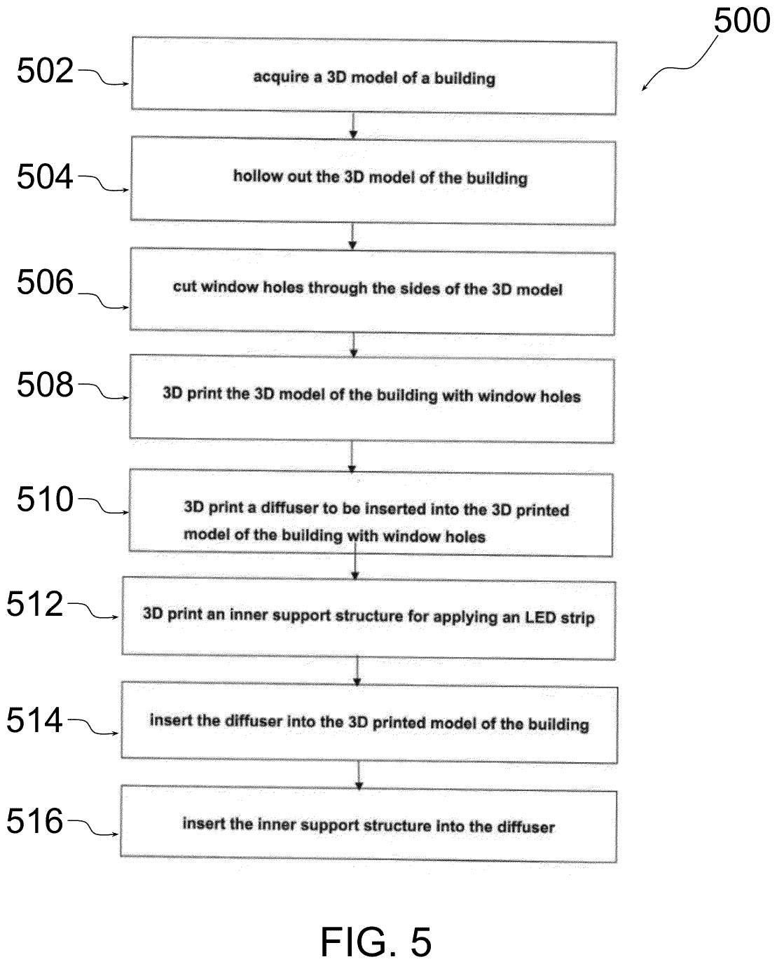

Referring to FIG. 5, a top-level flow chart is shown to help illustrate an embodiment 500 of a method of the invention for making an internally illuminable 3D model of a building based on a 3D model of the building, by 3D printing the building and the diffuser sequentially. This embodiment of the method of the invention is for creating internally illuminable 3D building models using 3D printing software, along with architecture software or computer-aided design (CAD) software.

The first step 502 of this embodiment of the method is to acquire a 3D model of a building one wishes to create. The 3D model of the building can later be translated into a format for use by a 3D printer. One can purchase a license to use an existing 3D digital building model. Alternatively, one can create a 3D model of a building using CAD software or 3D modeling software, by reference ti blueprints, architectural drawings, and photographs of the building one wants to model. There are also software applications which can create high quality scans photographically using a smart phone or camera (referred to as “photogrammetry”), as well as smart phone applications which can scan layouts and objects with 3D mappings.

Next, hollowing out 504 the 3D model of the building is necessary, if the 3D model of the building was solid initially. This step 504 can be done by a variety of methods, depending on the software one is using, from individually clicking and hiding walls to creating an inner object whose boundaries can be used to define an area of empty space.

Then, if windows are not empty space in the 3D model, cut window holes 506 through the sides of the hollow 3D model from step 504. These window holes can be cut out using the same techniques as when hollowing the 3D model of a building in step 504.

Next, one 3D prints 508 the 3D model of the building with window holes, printing the entire 3D model at the desired scale.

Then, one 3D prints 510 a diffuser of a shape that can be inserted into the 3D printed model of the building with window holes, such that the 3D printed diffuser can be fit inside the 3D printed building exterior.

If an inner support structure is desired, one can 3D-print such a structure as step 512 in the process. If an inner support structure was included, affix the light source to the support structure.

The inner diffuser is then inserted 514 into the building exterior.

All that is left is to then insert 516 the support structure with the light source into the inner diffuser.

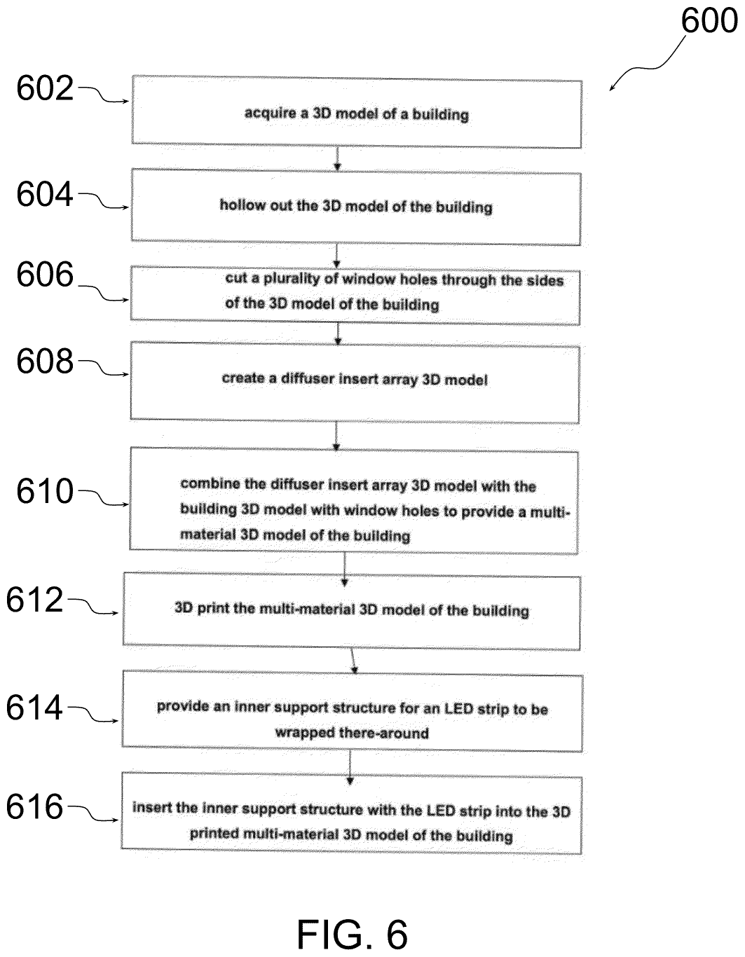

With reference to FIG. 6, a top-level flow chart shows a process 600 for making an internally illuminable 3D model of a building based on a 3D model of the building, by 3D printing the building and a diffuser insert array simultaneously.

The embodiment of the process 600 differs from the embodiment of the process of FIG. 5 by incorporating the 3D printing instruction for a diffuser array into the same file as the 3D printing instruction for the building, flagging for the printer the different materials to be used per structure respectively, and printing both structures together (such as one building structure with a diffuser in each window hole of the building structure). The process of FIG. 6 is facilitated by the ability of some 3D printers to use multiple filaments, either by printing using multiple nozzles, or by feeding different filaments through a single 3D printer nozzle.

In particular, the process 600 begins with acquiring 602 a 3D model of a building. Next, the 3D model of the building is hollowed out 604. Then, a plurality of window holes are cut 606 through the sides of the 3D model of the building. Next a diffuser insert array 3D model is created 608. Then, combine 610 the diffuser insert array 3D model with the building 3D model with window holes to provide a multi-material 3D model of the building. Next, 3D print 612 the multi-material 3D model of the building. and diffuser insert array. Then, provide 614 an inner support structure for an LED strip to be wrapped there-around. Next, insert 616 the inner support structure with the LED strip into the 3D printed multi-material 3D model of the building with the diffuser insert array to provide a completed building model having a diffuser in each window hole of the building model.

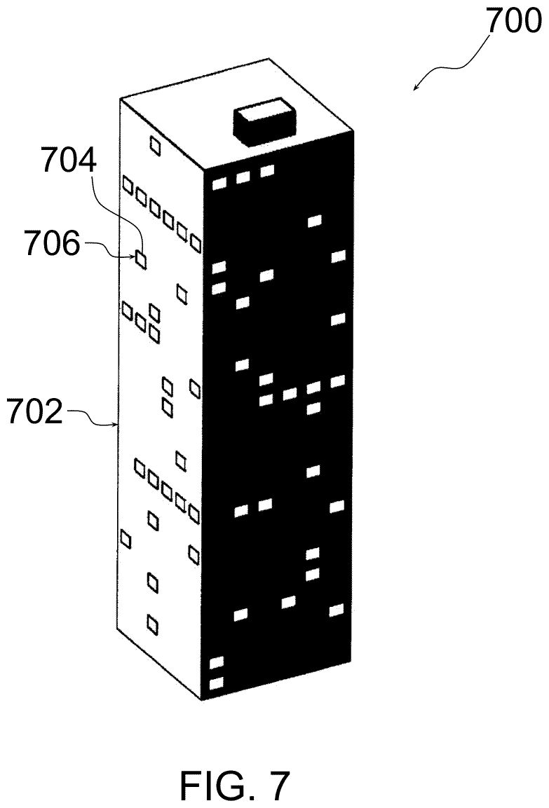

Referring to FIG. 7, an embodiment 700 of a solid model of a building 702 is shown having a plurality of window holes 704. The solid model of the building 702 has a diffuser insert 706 located within each window hole 704. All of the diffuser inserts 706 taken together are represented by the diffuser insert array 3D model as in step 608 of FIG. 6. Each diffuser insert 706 of the diffuser insert array 3D model is 3D printed simultaneously with the 3D printing of the solid model of the building 702 as part of the same multi-material 3D model by a multi-material 3D printer. Each light diffuser insert 706 is also internally illuminable by a vertically distributed lighting arrangement 400 applied to an inner support structure 300 located inside the solid model of the building 702, e.g., as shown in FIG. 4.

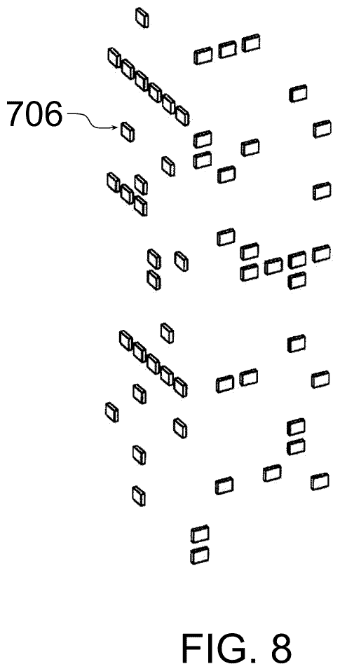

With reference to FIG. 8 an embodiment of the diffuser insert array 3D model is shown, as set forth in step 608 of FIG. 6 and in FIG. 7. In FIG. 8, each diffuser insert 706 is shown at a location coinciding with the location of a window hole 704, without showing the solid model of the building 702, and without showing the window holes 704 of the solid model of the building 702.

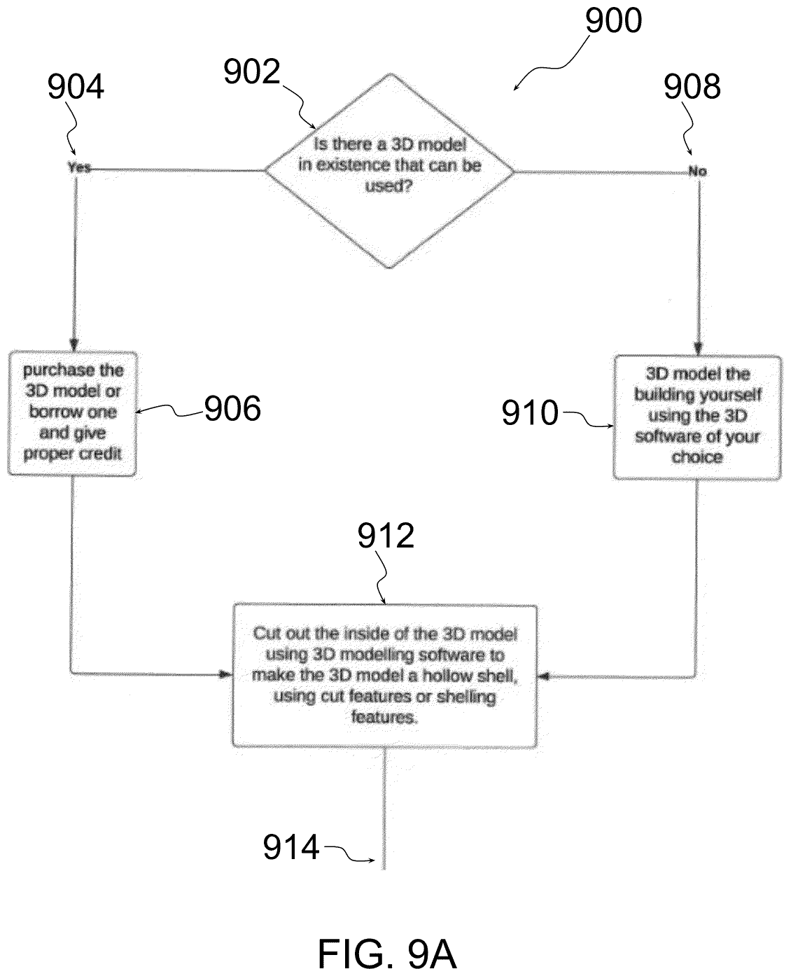

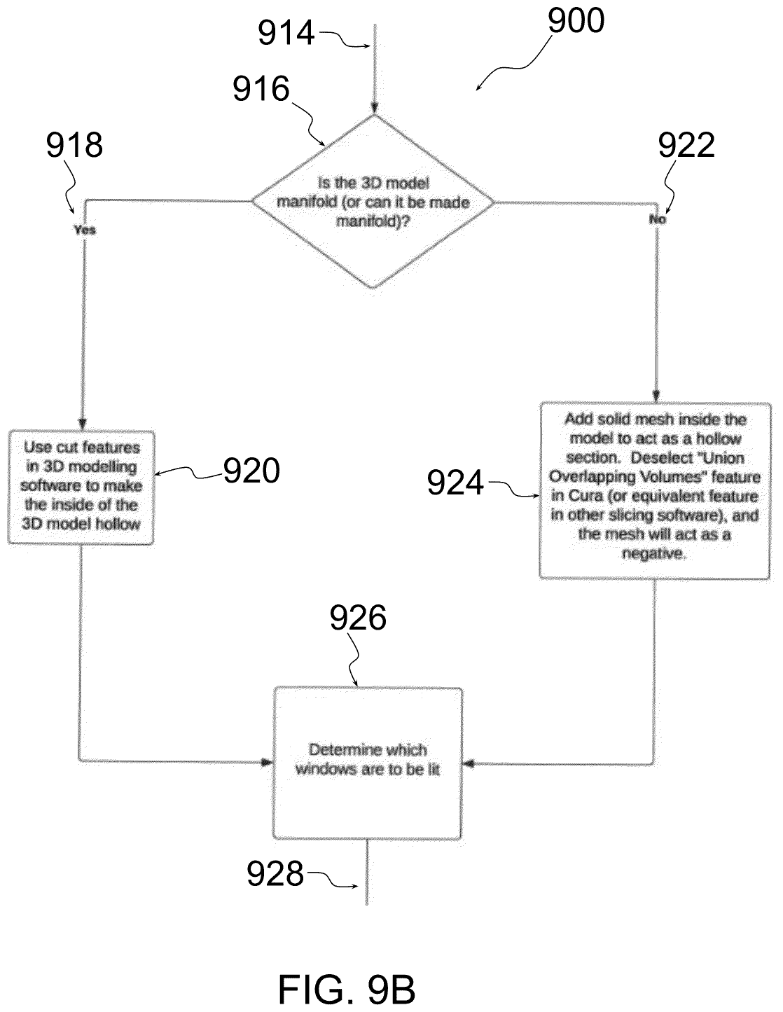

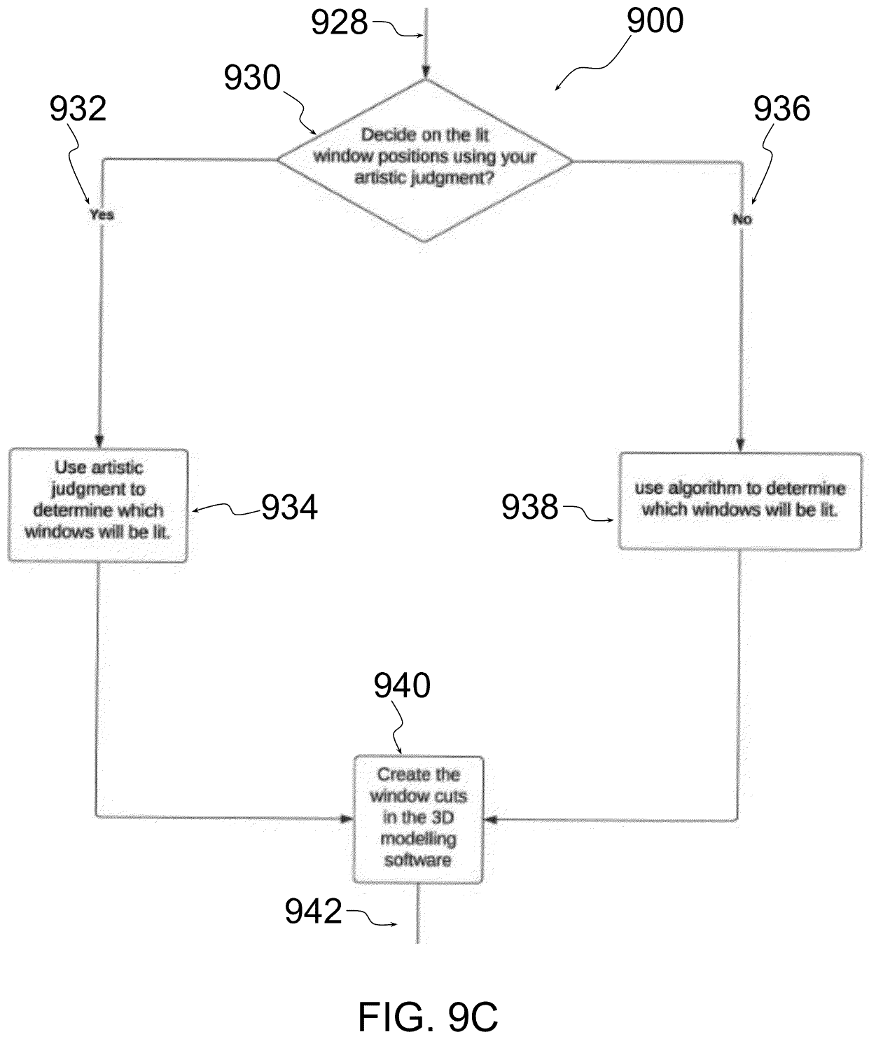

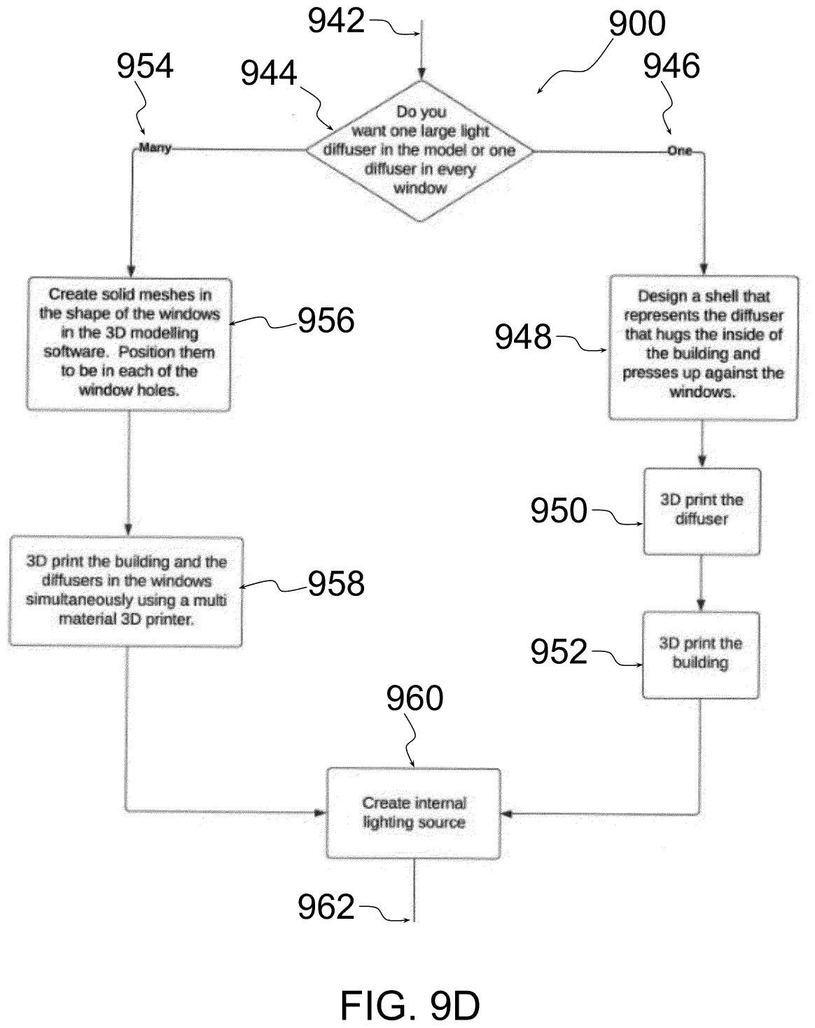

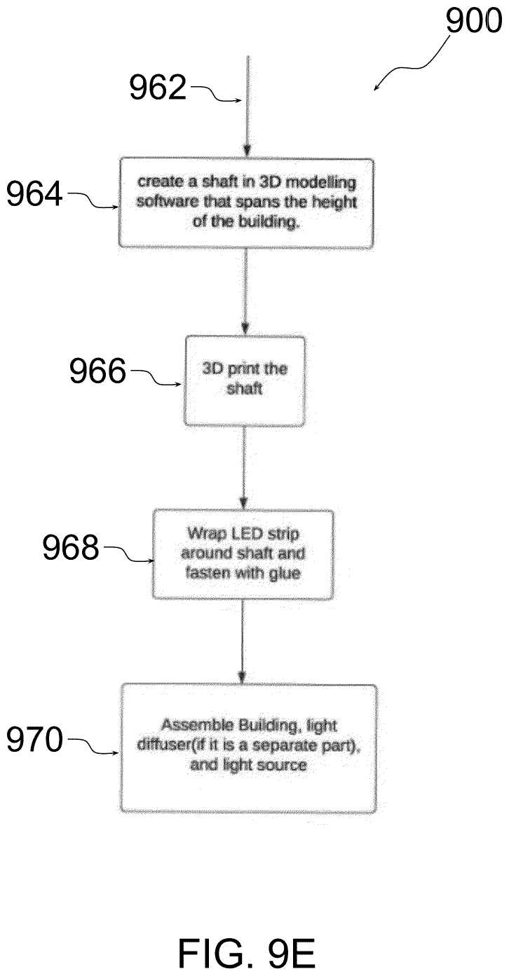

Referring to FIGS. 9A-9E, sequential portions of a detailed flow chart are presented of an embodiment of a process 900 for making an internally illuminable 3D printed solid model of a building based on a 3D model of the building. The steps of the process shown in FIG. 9A lead to the steps of the process shown in FIG. 9B, and so on until the steps of the process lead to and include those shown in FIG. 9E.

The process 900 begins with a yes/no question 902 which asks whether a 3D model of the building that a user wishes to create already exists. If “yes” 904, acquire 906 the 3D model with best practices (by buying or borrowing a 3D model, and giving credit to the creator of the existing 3D model); if “no” 908, the user must create 910 the 3D model using 3D modeling software.

Starting with the 3D model attained using either step 906 or 910, the inside of the 3D model is cut out using 3D modeling software so as to make the 3D model into a hollow shell 3D model, using cut features of the 3D modeling software, or using shelling features of 3D modeling software.

The process of FIG. 9A continues 914 to FIG. 9B whereupon a yes/no question 916 asks whether the 3D model is manifold, or whether the 3D model can be made manifold (having the topological property of a volume in which every point has a neighborhood that is homeomorphic to the interior of a sphere). If “yes” 918, one can use cut features in 3D modeling software to hollow out 920 the inside of the 3D model of the building. If “no” 922, one adds a solid mesh 924 within the 3D model, the solid mesh acting as a hollow section.

Next, 3D building model resulting from either step 920 or 924 is ready for determining 926 which windows of the 3D building model are to be lit, i.e., are to be illuminable by a central extended light source.

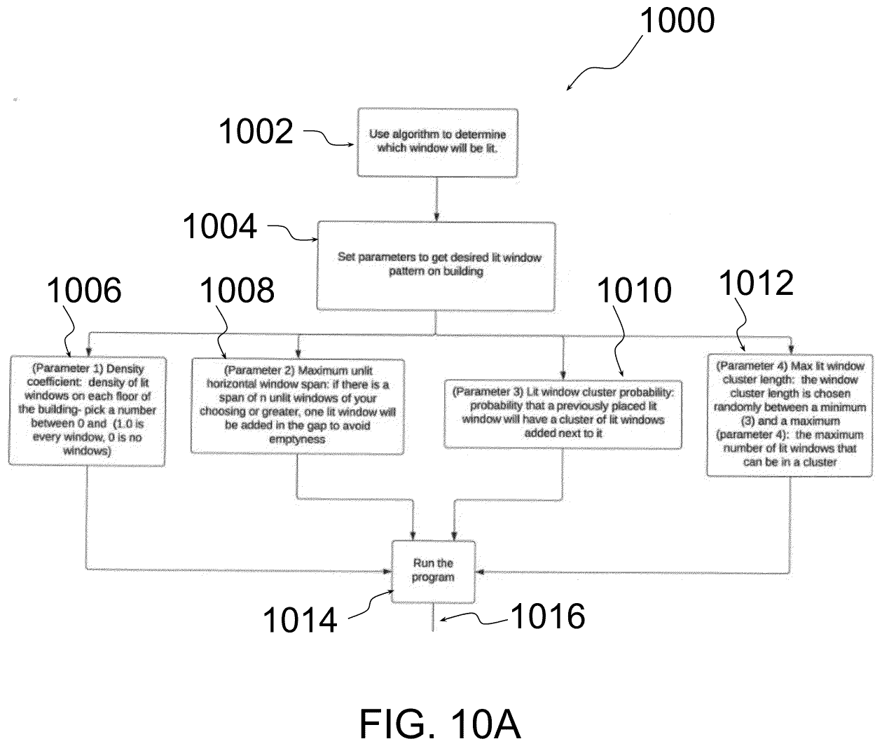

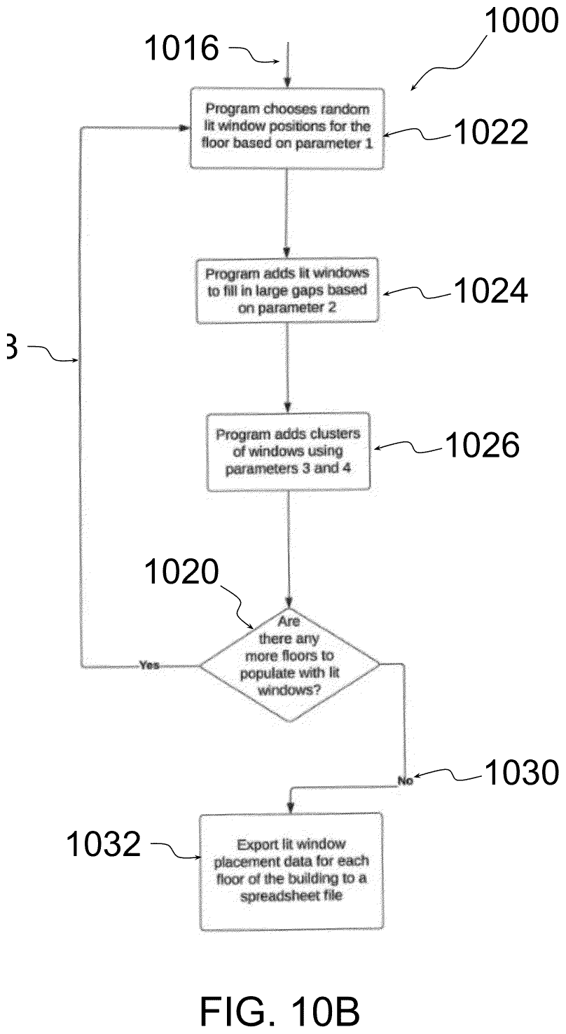

The process of FIG. 9B continues 928 to FIG. 9C whereupon a yes/no question 930 is asked regarding whether one wants to use artistic judgment to determine which windows will be lit 932, or not 936 (instead using a window selection algorithm to determine which windows will be lit). If “yes” 932, one uses artistic judgment to choose which windows are to be lit 934. If “no” 936, an algorithm is used to determine which windows will be lit, such as assigning each window a number and using a random number generator to select windows, or using the algorithm set forth in FIGS. 10A and 10B. Notably, algorithms can be used together with artistic judgment, such as algorithmically selecting windows until an aesthetic ratio is reached, for example

Once windows which are to be lit are selected, the next step 940 is to create the window cuts in the 3D building model using the 3D modeling software. After step 940, one proceeds 942 to FIG. 9D, and to the decision 944 of whether one wants a single internal light diffuser, or whether one wants a diffuser in every window to be lit.

Referring to FIG. 9D, if one chooses to use a single 946 internal light diffuser, one must then design 948 a shell that represents a diffuser that hugs the inside of the building and presses up against (or is close to) all of the window openings. Then, one 3D prints 950 the diffuser. Next, one 3D prints 952 the building. Then, one creates 960 an internal lighting source.

If one chooses 954 to include one diffuser in each window to be lit, one then must create 956 solid meshes in the shape of the windows in the 3D modeling software, and then position a solid mesh in each of the window holes of the 3D building model. Next, one 3D prints 958 the building and the diffusers in the windows simultaneously using a multi-material 3D printer. Then, one creates 960 an internal lighting source. After step 960, one proceeds 962 to FIG. 9E, and to step 964.

With reference to FIG. 9E, one next must create 964 a shaft in 3D modeling software that spans the height of the building, or is at least tall enough to at least cast light on substantially all of the inside of the building. The model of the shaft can then be 3D printed 966. Next, an LED strip is wrapped 968 around the shaft and then fastened to the shaft using glue, or using tacks, for example. Finally, the building model, light diffuser (if a separate part), and the light source are assembled 970 so as to provide an internally illuminable 3D printed model of a building based on a 3D model of the building.

With reference to FIGS. 10A and 10B, a flow chart shows details of step 938 of FIG. 9C, a method for determining which windows of the solid model of the building will be lit.

FIG. 10A begins by stating the goal of using 1002 an algorithm for selecting windows which are to be lit, as also recited in step 938 of FIG. 9C, which is then detailed in subsequent steps, starting with first setting 1004 algorithm parameters, which breaks out into four parameters to be set in steps 1006, 1008, 1010, and 1012.

First, a density coefficient is set 1006, where the density of lit windows on each floor of the building is set by picking a number between 0 and 1, inclusive, where 1 represents every window on that floor being lit, and 0 represents no windows on that floor being lit.

Next, a maximum unlit horizontal window span is selected 1008, such that if there is a span of ‘n’ unlit windows or greater, one lit window will be added in the span of unlit windows to avoid emptiness.

Then, a lit window cluster probability is set 1010, which is the probability that a previously placed lit window will have a cluster of lit windows added next to it.

Next, a maximum lit window cluster length is set 1012, where the window cluster length is chosen randomly between a minimum (e.g., 3), and the maximum lit window cluster length set by the user. Thus, the maximum number of lit windows that can be in a cluster of lit windows is no more than the maximum lit window cluster length.

After the four parameters have been set, the program is run 1014, which involves following 1016 the steps set forth in FIG. 10B.

Referring to FIG. 10B, the first step executed 1014 by the program is to choose random lit window positions 1022 for the floor based on the density coefficient of step 1006. Next, lit windows are added to fill in large gaps based on the maximum unlit horizontal window span of step 1008. Then, clusters of windows are added using the lit window cluster probability of step 1010, and the maximum lit window cluster length of step 1012. Next, the program determines whether there are any more floors to populate with lit windows. If so, then control is transferred back to step 1022.

Thus, the program in this embodiment is run as a loop 1018 which works to select, floor by floor, which windows of the building model will be lit (using the parameters set forth in FIG. 10A) until all floors have been populated with lit windows. Once there are no 1030 floors left to evaluate, the program's suggested lit window placement choices 1032 are exported to a spreadsheet file, or directly to the 3D modeling software being used.

Other modifications and implementations will occur to those skilled in the art without departing from the spirit and the scope of the invention as claimed. Accordingly, the above description is not intended to limit the invention, except as indicated in the following claims.

What is claimed is:

1. A method for making an internally illuminable 3D printed model of a building based on a 3D model of the building, the method comprising:
acquiring a 3D model of a building;
using 3D software, hollowing out the 3D model of the building, so as to provide a 3D model of the building having a cavity with a downward opening;
using 3D software, cutting a plurality of window holes through at least one side of the 3D model of the building having a cavity so as to provide a 3D model of the building having a cavity and a plurality of window holes;
using 3D software, creating a diffuser insert array 3D model by including a diffuser insert for each location of a window hole so as to provide an array of diffuser inserts, each diffuser insert being located so as to reside within each window hole of the plurality of window holes;
using 3D software, combining the building 3D model with the diffuser insert array 3D model by registering the building 3D model with respect to the diffuser insert array 3D model so as to produce a multi-material 3D model of the building, the building 3D model to be printed with at least one building material, and the diffuser insert array 3D model to be printed with at least one diffuser material;
using a 3D printer, 3D printing the multi-material 3D model of the building using the at least one building material, and the at least one diffuser material;
providing an inner support structure for supporting a vertically distributed lighting arrangement;
applying the vertically distributed lighting arrangement to the inner support structure; and
inserting the inner support structure with the vertically distributed lighting arrangement applied thereto into the 3D printed multi-material 3D model of the building to provide the internally illuminable 3D printed model of the building.

2. The method of claim 1, wherein the inner support structure is a rod.

3. The method of claim 1, wherein applying the vertically distributed lighting arrangement to the inner support structure includes wrapping an LED strip around the inner support structure.

4. The method of claim 1, wherein the inner support structure extends centrally through the 3D model of the building.

5. The method of claim 1, wherein providing the inner support structure for supporting the vertically distributed lighting arrangement includes:
using 3D software, creating an inner support structure for supporting a vertically distributed lighting arrangement, the inner support structure attached to a bottom plate, the bottom plate configured to be attached to the multi-material 3D model of the building so as to cover the downward opening of the multi-material 3D model of the building; and
using a 3D printer, 3D printing the inner support structure for supporting the vertically distributed lighting arrangement.

6. The method of claim 1, wherein the steps of:
using 3D software, hollowing out the 3D model of the building, so as to provide a 3D model of the building having a cavity with a downward opening, and
using 3D software, cutting a plurality of window holes through at least one side of the 3D model of the building having a cavity so as to provide a 3D model of the building having a cavity and a plurality of window holes,
are performed simultaneously by:
providing a negative 3D model representing the cavity with a downward opening and a plurality of window holes;
adding the negative 3D model to the 3D model of the building so as to provide a 3D model of the building having a cavity and a plurality of window holes; and
deselecting “Union Overlapping Volumes” feature so that the mesh can act as a negative.

7. The method of claim 1, wherein the 3D model of the building is a 3D model mesh, and
wherein the steps of: using 3D software, hollowing out the 3D model of the building, so as to provide a 3D model of the building having a cavity with a downward opening, and using 3D software, cutting a plurality of window holes through at least one side of the 3D model of the building having a cavity so as to provide a 3D model of the building having a cavity and a plurality of window holes, include the steps of:
using 3D software, converting the 3D model mesh into a solid model of the building;
using cut features in the 3D modeling software to make the inside of the 3D model hollow; and
using cut features in the 3D modeling software to cut a plurality of window holes through at least one side of the solid model of the building so as to provide a solid model of the building having a plurality of window holes.

8. The method of claim 1, wherein cutting a plurality of window holes through at least one side of the solid model of the building so as to provide a solid model of the building having a plurality of window holes includes:
before each hole of the plurality of window holes is cut, determining where each window hole of the plurality of window holes is to be cut, thereby determining locations of lit windows in the centrally illuminable 3D printed model of the building.

9. The method of claim 8, wherein determining where each window hole of the plurality of window holes is to be cut includes:
determining locations of lit windows according to personal preference.

10. The method of claim 8, wherein determining where each window hole of the plurality of window holes is to be cut includes:
determining locations of lit windows according to an automated process.

11. The method of claim 10, wherein the automated process includes:
setting parameters for each floor of the building so as to obtain a desired lit window location pattern for each floor of the building; and
determining the desired lit window location pattern for each floor of the building using the parameters.

12. The method of claim 11, wherein setting parameters includes:
setting a density coefficient that determines a density of lit windows on each floor of the building, the density coefficient for each floor ranging from no lit windows on a floor to all lit windows on a floor;
setting a maximum unlit horizontal window span, such that for each span of unlit windows greater than the maximum unlit horizontal window span, a lit window is inserted somewhere within the span;
setting a lit window cluster probability that determines the likelihood that a previously placed lit window will have a cluster of lit windows placed next to the previously placed lit window; and
setting a maximum lit window cluster length that determines a maximum number of lit windows that can be in a cluster of lit windows.

13. An internally illuminable 3D printed model of a building based on a 3D model of the building, the internally illuminable 3D printed model made according to a method comprising:
acquiring a 3D model of a building;
using 3D software, hollowing out the 3D model of the building, so as to provide a 3D model of the building having a cavity with a downward opening;
using 3D software, cutting a plurality of window holes through at least one side of the 3D model of the building having a cavity so as to provide a 3D model of the building having a cavity and a plurality of window holes;
using 3D software, creating a diffuser insert array 3D model by including a diffuser insert for each location of a window hole so as to provide an array of diffuser inserts, each diffuser insert being located so as to reside within each window hole of the plurality of window holes;
using 3D software, combining the building 3D model with the diffuser insert array 3D model by registering the building 3D model with respect to the diffuser insert array 3D model so as to produce a multi-material 3D model of the building, the building 3D model to be printed with at least one building material, and the diffuser insert array 3D model to be printed with at least one diffuser material;
using a 3D printer, 3D printing the multi-material 3D model of the building using the at least one building material, and the at least one diffuser material;
providing an inner support structure for supporting a vertically distributed lighting arrangement;
applying the vertically distributed lighting arrangement to the inner support structure; and
inserting the inner support structure with the vertically distributed lighting arrangement applied thereto into the 3D printed multi-material 3D model of the building to provide the internally illuminable 3D printed model of the building.

14. The internally illuminable 3D printed model of claim 13, wherein the inner support structure is a rod.

15. The internally illuminable 3D printed model of claim 13, wherein applying the vertically distributed lighting arrangement to the inner support structure includes wrapping an LED strip around the inner support structure.

16. The internally illuminable 3D printed model of claim 13, wherein the inner support structure extends centrally through the 3D model of the building.

17. The internally illuminable 3D printed model of claim 13, wherein providing the inner support structure for supporting the vertically distributed lighting arrangement includes:
using 3D software, creating an inner support structure for supporting a vertically distributed lighting arrangement, the inner support structure attached to a bottom plate, the bottom plate configured to be attached to the multi-material 3D model of the building so as to cover the downward opening of the multi-material 3D model of the building; and
using a 3D printer, 3D printing the inner support structure for supporting the vertically distributed lighting arrangement.

18. The internally illuminable 3D printed model of claim 13, wherein the steps of:
using 3D software, hollowing out the 3D model of the building, so as to provide a 3D model of the building having a cavity with a downward opening, and
using 3D software, cutting a plurality of window holes through at least one side of the 3D model of the building having a cavity so as to provide a 3D model of the building having a cavity and a plurality of window holes,
are performed simultaneously by:
providing a negative 3D model representing the cavity with a downward opening and a plurality of window holes;
adding the negative 3D model to the 3D model of the building so as to provide a 3D model of the building having a cavity and a plurality of window holes; and
deselecting “Union Overlapping Volumes” feature so that the mesh can act as a negative.

19. The internally illuminable 3D printed model of claim 13, wherein the 3D model of the building is a 3D model mesh, and
wherein the steps of: using 3D software, hollowing out the 3D model of the building, so as to provide a 3D model of the building having a cavity with a downward opening, and using 3D software, cutting a plurality of window holes through at least one side of the 3D model of the building having a cavity so as to provide a 3D model of the building having a cavity and a plurality of window holes, include the steps of:
using 3D software, converting the 3D model mesh into a solid model of the building;
using cut features in the 3D modeling software to make the inside of the 3D model hollow; and
using cut features in the 3D modeling software to cut a plurality of window holes through at least one side of the solid model of the building so as to provide a solid model of the building having a plurality of window holes.

20. The internally illuminable 3D printed model of claim 13, wherein cutting a plurality of window holes through at least one side of the solid model of the building so as to provide a solid model of the building having a plurality of window holes includes:
before each hole of the plurality of window holes is cut, determining where each window hole of the plurality of window holes is to be cut, thereby determining locations of lit windows in the centrally illuminable 3D printed model of the building.

21. The internally illuminable 3D printed model of claim 20, wherein determining where each window hole of the plurality of window holes is to be cut includes:
determining locations of lit windows according to personal preference.

22. The internally illuminable 3D printed model of claim 20, wherein determining where each window hole of the plurality of window holes is to be cut includes:
determining locations of lit windows according to an automated process.

23. The internally illuminable 3D printed model of claim 22, wherein the automated process includes:
setting parameters for each floor of the building so as to obtain a desired lit window location pattern for each floor of the building; and
determining the desired lit window location pattern for each floor of the building using the parameters.

24. The internally illuminable 3D printed model of claim 23, wherein setting parameters includes:
setting a density coefficient that determines a density of lit windows on each floor of the building, the density coefficient for each floor ranging from no lit windows on a floor to all lit windows on a floor;
setting a maximum unlit horizontal window span, such that for each span of unlit windows greater than the maximum unlit horizontal window span, a lit window is inserted somewhere within the span;
setting a lit window cluster probability that determines the likelihood that a previously placed lit window will have a cluster of lit windows placed next to the previously placed lit window; and
setting a maximum lit window cluster length that determines a maximum number of lit windows that can be in a cluster of lit windows.
